(19) United States
(12) Patent Application Publication
(10) Pub. No.: US 2026/0257858 A1
(43) Pub. Date: Sep. 3, 2026

(54) STORAGE SYSTEM

(71) Applicant: AutoStore Technology AS, Nedre Vats (NO)

(72) Inventors: Trond Austrheim, Etne (NO); Synnøve Solberg Matre, Sandeid (NO); Ole Alexander Mæhle, Etne (NO); Frode Robberstab, Nedre Vats (NO)

(21) Appl. No.: 19/164,810

(22) PCT Filed: Mar. 14, 2024
(86) PCT No.: PCT/EP2024/056861

§ 371 Date: Sep. 12, 2025

(30) Foreign Application Priority Data
Mar. 14, 2023 (NO) 20230272

(51) Int. Cl. B65G 1/04

(52) U.S. Cl. CPC B65G 1/0464

(57) ABSTRACT

A storage system for storage containers comprising a first framework structure, for operating a container handling vehicle; a vertically moveable lifting frame for lifting a storage container from storage columns; a second framework structure for operating a vehicle and a vertically moveable lifting frame for lifting a container from the storage columns; the first structure being below the second structure, and each of the structures defining storage columns for containers on top of one another in stacks; the second structure comprising a transfer column for transferring a container by a vehicle and with an open lower end connected to the first structure by a column for guiding the lifting frame of a vehicle from the lower end of the transfer column to a buffer column of the first framework structure; a lower section of the guiding column can have extending elements being moveable between a first and a second position.

### FIELD

The present disclosure relates to a storage system for storage containers.

### BACKGROUND

FIG. 1 discloses a prior art automated storage and retrieval system 1 (i.e. a storage system), with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and a wheel assembly featuring first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 2 comprising container connectors 3, adapted to engage connecting recesses 13 at an upper rim of the sidewalls 14 of a storage container 106, see FIG. 5, and guiding pins 4. The guiding pins 4 are arranged to interact with guiding pin recesses 7 at the corners of the storage container and ensure a correct alignment of the lifting frame 2 and container connectors 3 relative to the storage container. The guiding pins 4 will also assist in guiding the lifting frame 2 relative to the upright members of the storage column 105. The lifting frame 2 can be lowered from the vehicle 201,301,401 so that the position of the lifting frame 2 with respect to the vehicle 201,301,401 can be adjusted in a third direction Z which is orthogonal the first direction X and the second direction Y. The lifting device of the container handling vehicle 201 is located within the vehicle body 201a in FIG. 2.

To raise or lower the lifting frame 2 (and optionally a connected storage container 106), the lifting frame 2 is suspended from a band drive assembly by lifting bands 5. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y-and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference. The conveyor system in WO2014/075937A1 is a storage container lift arranged to transport a storage container between two vertically separated framework structures 100. A potential disadvantage of the storage container lift is that it is a potential single point of failure and repair of a defective storage container lift may be time-consuming.

When a storage container 106 stored in one of the storage columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the storage system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the storage 1 comprises a control system 500 which typically is computerized and which typically comprises a database for keeping track of the storage containers 106.

The aim of the present disclosure is to provide a storage system in which storage containers may be transferred between two vertically separate framework structures in an improved manner.

### SUMMARY

This summary is provided to introduce in simplified form a selection of concepts that are further described herein. The summary is not intended to identify key or essential features of the invention.

The present disclosure is defined by the attached claims and in the following:

In a first aspect, the present disclosure provides a storage system for storage containers, the storage system comprising a first framework structure, upon which a first container handling vehicle is arranged to operate, and a second framework structure upon which a second container handling vehicle is arranged to operate;
the first framework structure is arranged below the second framework structure, and each of the first and the second framework structures defines a plurality of storage columns in which storage containers are arranged one on top of another in vertical stacks;
each of the first container handling vehicle and the second container handling vehicle comprises a vehicle body and a vertically moveable lifting frame for lifting a storage container from the storage columns;
the second framework structure comprises a transfer column through which the second container handling vehicle may transfer a storage container, the transfer column features an open lower end;
the lower end of the transfer column is connected to the first framework structure by a guiding column such that the lifting frame of the second container handling vehicle may be guided by the guiding column as it is lowered from the lower end of the transfer column to a buffer column of the first framework structure;
at least a lower section of the guiding column comprises vertically extending guide elements, the guide elements being moveable between a first position and a second position,
in the first position the guide elements are arranged to guide the vertical movement of a lifting frame being lowered between them, and
in the second position the guide elements are moved relative to the first position such that the first container handling vehicle may move into a location on the first framework structure above the buffer column unobstructed by the guide elements.

When in the first position the guide elements may prevent the first container handling vehicle from entering a position above the buffer column.

The lower open end of the transfer column is configured to allow passage of a lifting frame and a storage container connected to the lifting frame, i.e. allow passage of a lifting frame and a storage container between the transfer column and the guiding column

In an embodiment of the storage system, the guide elements may be moved away from one another when moving from the first position to the second position, such that the first container handling vehicle may move in between them, i.e. the first container handling vehicle may enter a location/position above the buffer column to retrieve a storage container from, or store a storage container in, the buffer column.

The guide elements may be moved away from one another such that the first container handling vehicle may move in between the guide elements to retrieve a storage container from the buffer column or lower a storage container into the buffer column.

In an embodiment of the storage system, the guide elements may be arranged on opposite sides at an upper end of the buffer column

In an embodiment of the storage system, the guide elements may be laterally moveable between the first position and the second position. The guide elements may be moved laterally by a linear or curved path.

In an embodiment of the storage system, the guide elements may be closer to a centreline, i.e. a vertical centreline, of the guiding column when the guide elements are in the first position than when the guide elements are in the second position.

In an embodiment of the storage system the lower section of the guiding column may comprise two guide elements, each guide element featuring two vertical corner sections, each of the corner sections configured to accommodate and guide a corresponding corner of the lifting frame of the second container handling vehicle, i.e. the corner sections of the guide elements are configured to accommodate and guide a corresponding corner of the lifting frame when the lifting frame is lowered or raised through the lower section of the guiding column.

Each of the corner sections of the guide elements may be configured to accommodate and guide a corresponding corner of the lifting frame of the second container handling vehicle when the guiding elements are in the first position, i.e. the corner sections are configured to accommodate and guide a corresponding corner of the lifting frame when the lifting frame moves in a vertical direction through the lower section.

When the guide elements are in the second position the shortest distance between the two guide elements is larger than the smallest width of the vehicle body of the first container handling vehicle. In other words, when the guide elements are in the second position at least a part of the container handling vehicle comprising the lifting frame may be accommodated between the guide elements such that the lifting frame may retrieve a storage container from the buffer column.

In an embodiment of the storage system, the buffer column may have a rectangular access opening, i.e. an opening at the upper end of the buffer column, and each of the corner sections of the guide elements coincide with a respective corner of the access opening when the guide elements are in the first position. In other words, a vertical projection of the corner sections of the guide elements will coincide with the respective corners of the access opening of the buffer column.

Each of the corner sections of the guide elements may be vertically aligned with a respective corner of the access opening when the guide elements are in the first position.

The corners of the access opening of the buffer column may be seen as an extension of the corner sections of the guide elements when the guide elements are in the first position, such that the lifting frame of the second container handling vehicle is guided when moved between the buffer column and the guiding column.

In an embodiment of the storage system, the guide elements may be connected to at least one actuator assembly, the actuator assembly being configured to move the guide elements between the first position and the second position.

The actuator assembly may be in connection, or controlled by, a control system such that the guide elements are moved to the first position when a storage container is to be retrieved from or delivered to the buffer column by the second container handling vehicle, and moved to the second position when a storage container is to be retrieved from or delivered to the buffer column by the first container handling vehicle. The control system may be a control system as described above in connection with the prior art storage systems.

The actuator assembly may comprise a motor or a linear actuator configured to move at least one guide element between the first and second position, optionally via a movement transfer mechanism such as a crank assembly.

The actuator assembly may comprise a motor connected to at least one guide element via a movement transfer mechanism, e.g. a crank assembly, configured to transform a rotational movement of the motor into a lateral movement of the guide element, the lateral movement may be along a linear or curved pathway.

The actuator assembly may comprise a motor or linear actuator connected to the at least one guide element via a scissor mechanism, optionally via a movement transfer mechanism

The actuator assembly may be configured to move the guide elements between the first position and the second position in a linear horizontal direction.

In an embodiment of the storage system, the guide elements may be taller than the first container handling vehicle.

In an embodiment of the storage system, the first and second container handling vehicle may be identical.

In an embodiment of the storage system, centrelines of the transfer column, the guiding column and the buffer column may be colinear.

In an embodiment of the storage system, each of the first framework structure and the second framework structure may comprise a rail system upon which the first container handling vehicle and the second container handling vehicle, respectively, may move in two perpendicular directions above the storage columns.

In an embodiment, the storage system may comprise a rail system on which the container lifter may move in the two perpendicular directions, the rail system being arranged above the storage columns.

The first and the second framework structures may comprise a plurality of vertical column profiles defining the storage columns, the at least one transfer column and the corresponding buffer column. The vertical column profiles may comprise vertical corner sections for guiding corresponding corners of a lifting frame lowered or raised within the columns. At least the transfer column and the corresponding buffer column are vertically aligned.

The rail system may be arranged on top of, and supported by, the vertical column profiles. The rail system may comprise a first set of parallel rails arranged to guide movement of the container lifter in a first direction across the top of the framework structure, and a second set of parallel rails arranged perpendicular to the first set of rails to guide movement of the container lifter in a second direction being perpendicular to the first direction.

In an embodiment of the storage system, the first and second set of parallel rails are dual track rails.

In an embodiment of the storage system, the guide elements may be aligned with the vertical profiles defining the buffer column and the transfer column when in the first position. In the second position, the guide elements are moved away from a centre of the buffer column such that a vertical projection of each guide element is beyond at least one track of a rail at the upper end of the buffer column. The latter allows the first container handling vehicle to move to a location above the buffer column to retrieve or deliver a storage container.

In an embodiment of the storage system, any of the first and second container handling vehicle may comprise a wheel assembly featuring first and second sets of wheels which enable movement of the container handling vehicle in the two perpendicular directions on the rail system. The first set of wheels may be arranged to engage with a first set of parallel rails of the rail system, and the second set of wheels may be arranged to engage with a second set of parallel rails of the rail system. At least one of the sets of wheels can be lifted and lowered relative to the other set of wheels, so that the first set of wheels and/or the second set of wheels can be engaged with the respective set of rails at any one time.

In an embodiment, the storage system may comprise a plurality of first container handling vehicles and/or a plurality of second container handling vehicles.

In an embodiment of the storage system, the lower section of the guiding column may comprise a support fixed to the first framework structure, and the guiding elements may be moveably connected to the support. The support may be termed a support framework.

In an embodiment of the storage system, an upper section of the guiding column may comprise four vertical profiles, each profile comprising a vertical corner section configured to accommodate and guide a corresponding corner of the lifting frame of the second container handling vehicle.

In an embodiment of the storage system, an upper end of each of the vertical profiles are connected to the lower end of the transfer column and a lower end of each of the vertical profiles are connected to the support.

In an embodiment of the storage system, the support may comprise a framework of horizontal and vertical beams, the vertical beams arranged to hold the horizontal beams such that a lower level of the horizontal beams is higher than an upper level of the first container handling vehicle. The lower ends of the vertical profiles of the upper section of the guiding column are connected to the horizontal beams.

In an embodiment of the storage system, the buffer column comprises at least one stopper arranged to support a storage container in an upper portion of the buffer column.

In an embodiment of the storage system, the second framework structure may comprise a plurality of transfer columns, each transfer column connected to a corresponding buffer column of the first framework structure by a guiding column

The stopper may feature a support surface configured to support a bottom of a storage container. The support surface may be arranged at a distance from an upper end of the buffer column. The distance may be substantially equal to the height of the storage container, i.e. such that an upper rim of the storage container is at the level of, or slightly below, an upper level of the rail system of the first framework structure. The stopper may be connected to vertical profiles defining the buffer column.

In an embodiment of the storage system, the lifting frame may be configured to releasably connect to an upper portion of a storage container. The lifting frame may comprise grippers configured to releasably connect to connector recesses arranged in an upper rim of the storage container.

In a second aspect, the present disclosure provides a guiding column for a storage system according to any embodiment of the first aspect, the guiding column comprises a support and a plurality of guide elements, the guide elements are moveable between a first position and a second position,
in the first position the guide elements are arranged closer to a centreline of the guiding column, and
in the second position the guide elements are moved in a vertical direction away from the centreline of the guiding column, relative to the first position, providing an increased distance between the guide elements.

The guiding column of the second aspect may comprise any of the features disclosed for the guiding column of the storage system according to the first aspect.

In a third aspect, the present disclosure provides a method of transferring a storage container in a storage system according to any embodiment of the first aspect, the method comprising the steps of:
retrieving a storage container from a storage column of the second framework structure by use of the second container handling vehicle;
having the guide elements arranged in the first position; and
lowering the storage container through the transfer column and the guiding column and into the buffer column;
moving the guide elements to the second position (when the guide elements are in the second position, the first container handling vehicle has access to the buffer column); and
retrieving the storage container from the buffer column by use of the first container handling vehicle.

In an embodiment of the method, the storage container is lowered through the transfer column and the guiding column and into the buffer column until the storage container is supported upon a stopper inside the buffer column.

The method may comprise a step of disconnecting the storage container from the lifting frame of the second container handling vehicle, and raising the lifting frame up to the second framework structure, after the step of lowering the storage container through the transfer column and the guiding column and into the buffer column.

### BRIEF DESCRIPTION OF THE DRAWINGS

Embodiments are described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view of a prior art container handling vehicle, wherein a container lifting assembly is shown.

FIG. 5 is a perspective view of a storage container as used in the storage system in FIG. 1.

FIGS. 6 to 12 show an exemplary storage system according to the disclosure.

FIGS. 13a and 13b are schematic cross-sectional top views of the first and second position of the guiding elements 10 shown in FIGS. 6 to 12.

### DETAILED DESCRIPTION

In the following, embodiments will be discussed in more detail with reference to the appended drawings. The drawings are not intended to limit the invention to the illustrated subject-matter.

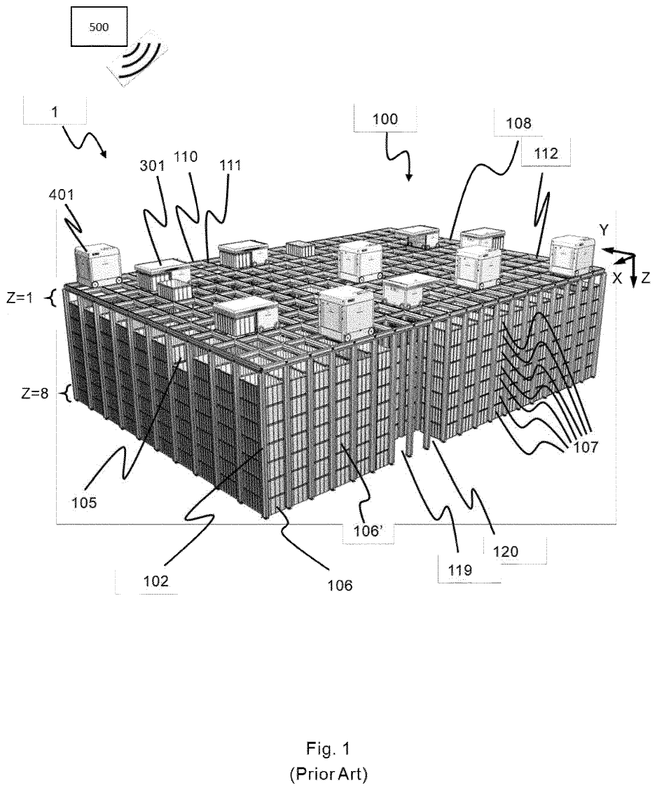

As discussed above, the prior art storage systems as shown in FIG. 1 are restricted regarding the height of the stacks of storage containers by the practical lifting height of the container handling vehicles, the weight that may be supported by the lower storage container in a stack of storage containers and/or the time used to dig up storage containers from a lower level of a stack. A prior art solution overcoming at least some of the limitations with regards to utilizing the full internal height of a building housing a storage system is disclosed in patent application WO 2014/075937 A1, in which a storage container lift is used to transfer storage containers between two vertically separated framework structures. A potential disadvantage of the prior art storage container lift is that it is a potential single point of failure and repair of a defective storage container lift may be time-consuming.

The inventive storage system is configured to overcome some of the restrictions of the prior art systems and/or provide a storage system in which storage containers may be transported between two vertically spaced framework structures, i.e. two framework structures arranged one above the other, in an improved manner. The inventive solution is simpler than the prior art storage container lift and is less service and maintenance intensive. Further, the solution is less prone to single point of failure since a defective container handling vehicle, i.e. the second container handling vehicle 501′ (see below) may easily be replaced by another container handling vehicle.

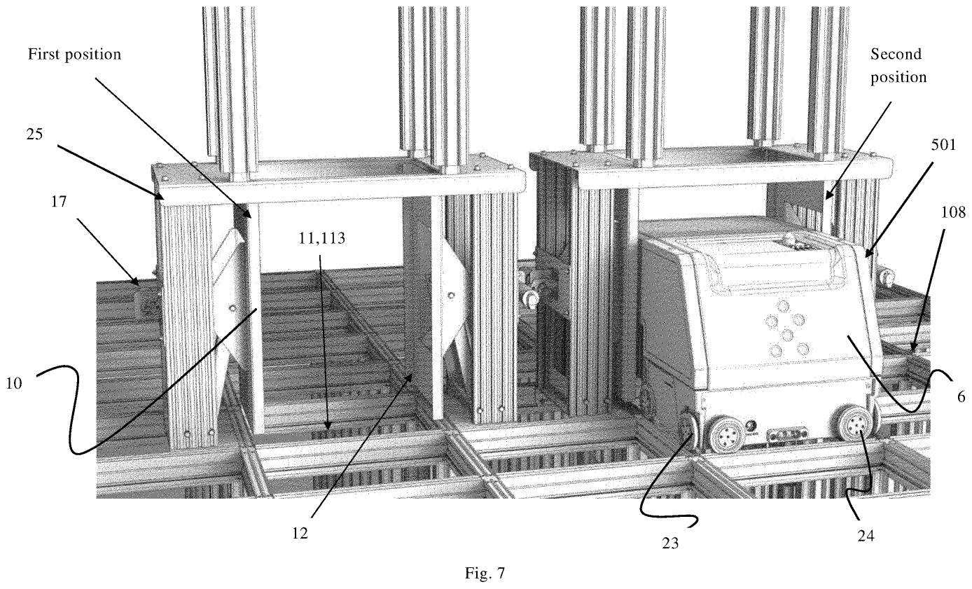

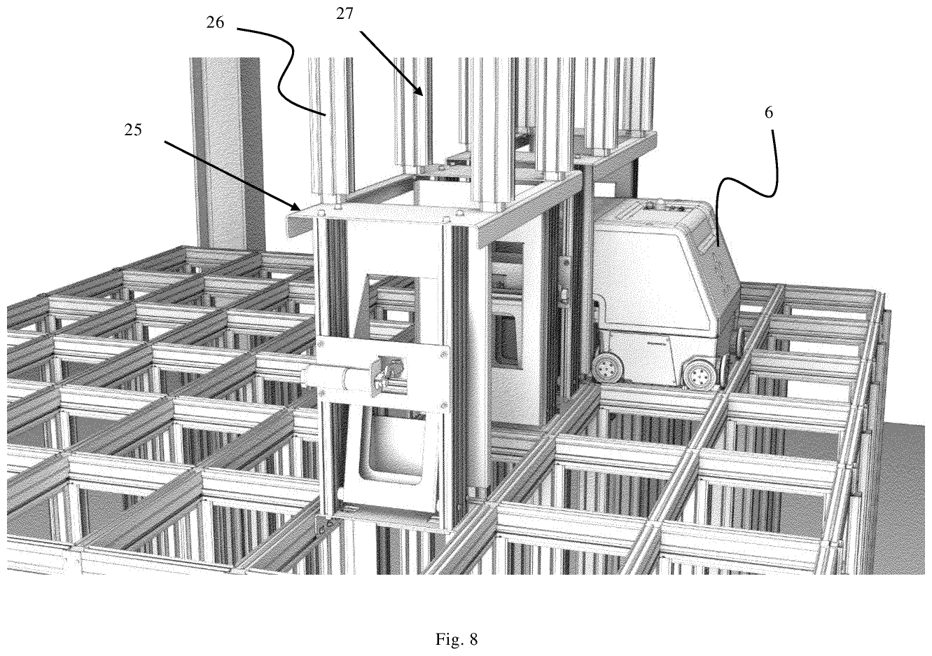

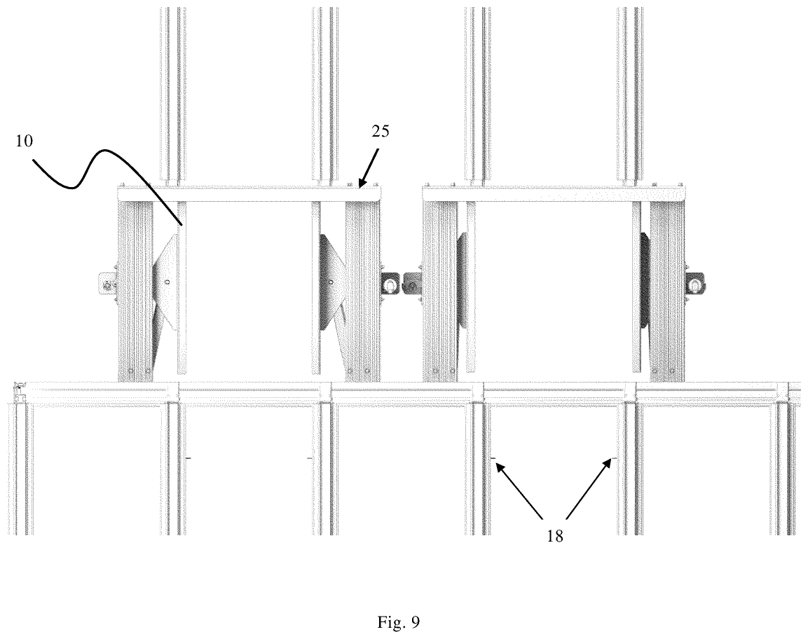

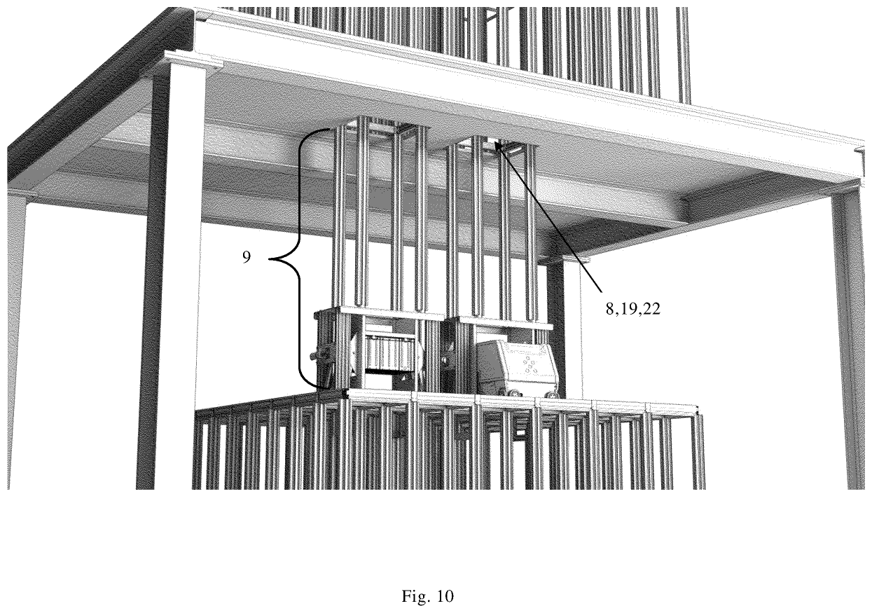

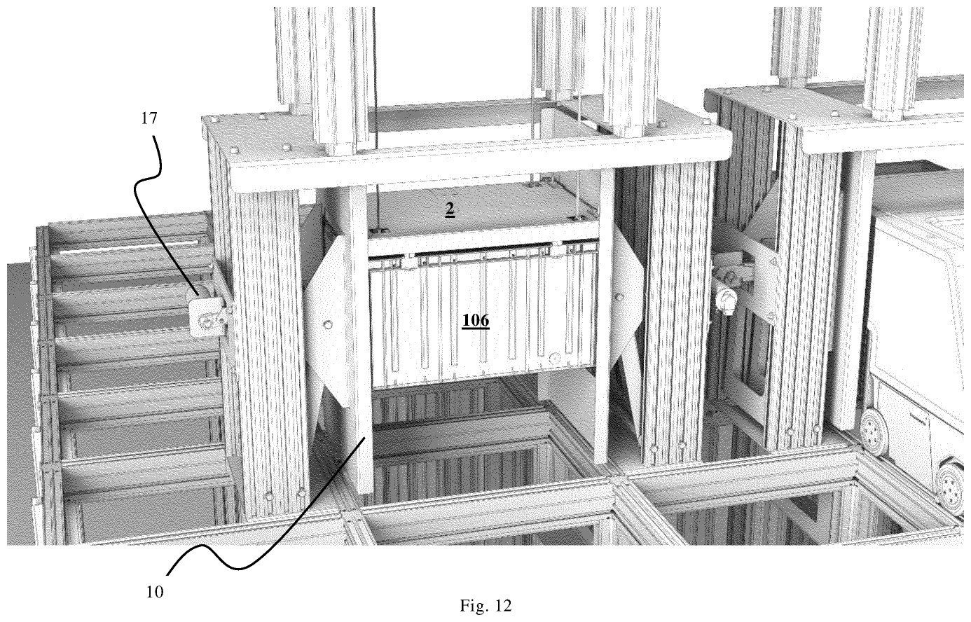

An exemplary storage system is shown in FIGS. 6-13. The storage system 1′ comprises a first framework structure 100 arranged above a second framework structure 100′. In the illustrated embodiment, the second framework structure is supported upon a mezzanine 20. The framework structures 100,100′ comprise vertical column profiles 102 defining a plurality of storage columns 105 in which storage containers 106 are supported on top of each other in vertical stacks.

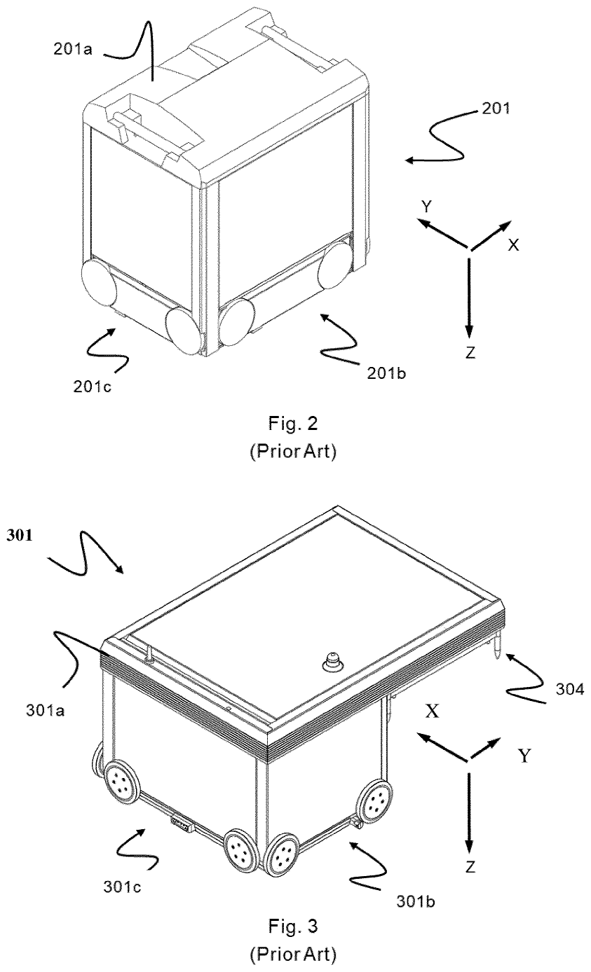

Each of the first framework structure 100 and the second framework structure 100′ features a rail system 108, arranged above the storage columns 105, and a container handling vehicle 501,501′ (i.e. a first container handling vehicle 501 and a second container handling vehicle 501′) configured to move in two perpendicular directions on the rail system 108. The container handling vehicles 501,501′ comprise a first set of wheels 28 and a second set of wheels 29 for moving on the respective rail system 108. The sets of wheels may be as described for the prior art container handling vehicles in FIGS. 2-4.

The framework structures 100,100′ and the storage containers 106 may be substantially similar to the corresponding features of the prior art storage system in FIG. 1. The framework structures 100,100′ have identically sized columns so that storage containers 106 in one can be used in the other.

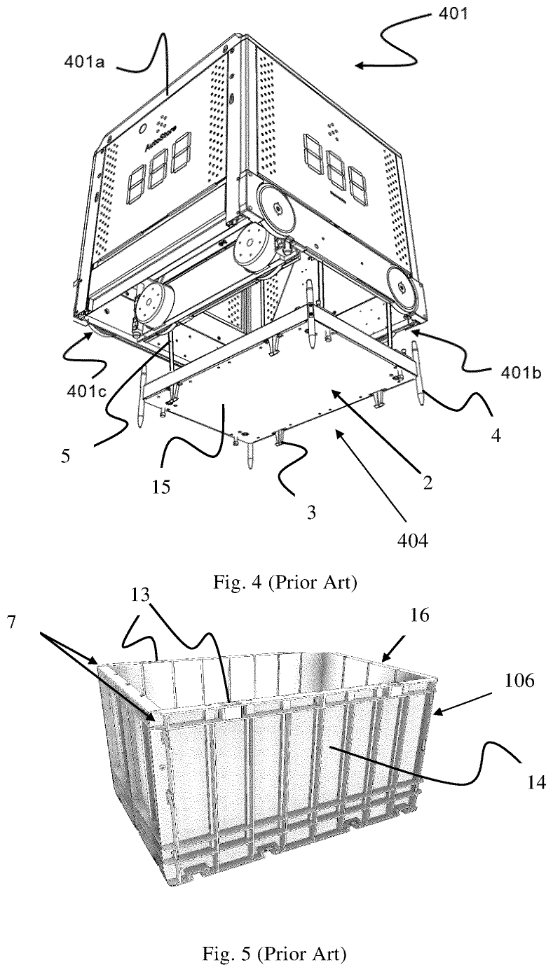

The container handling vehicles 501,501′ of the illustrated storage system are similar to the prior art container handling vehicle 301 in FIG. 3. However, in other embodiments the inventive storage system 1′ may advantageously use any type of suitable container handling vehicle, such as those shown in FIGS. 2 and 4.

The first and second container handling vehicles 501,501′ comprise a first set of wheels 23 and a second set of wheels 24 which enable movement of the container handling vehicles in two perpendicular directions on the rail system.

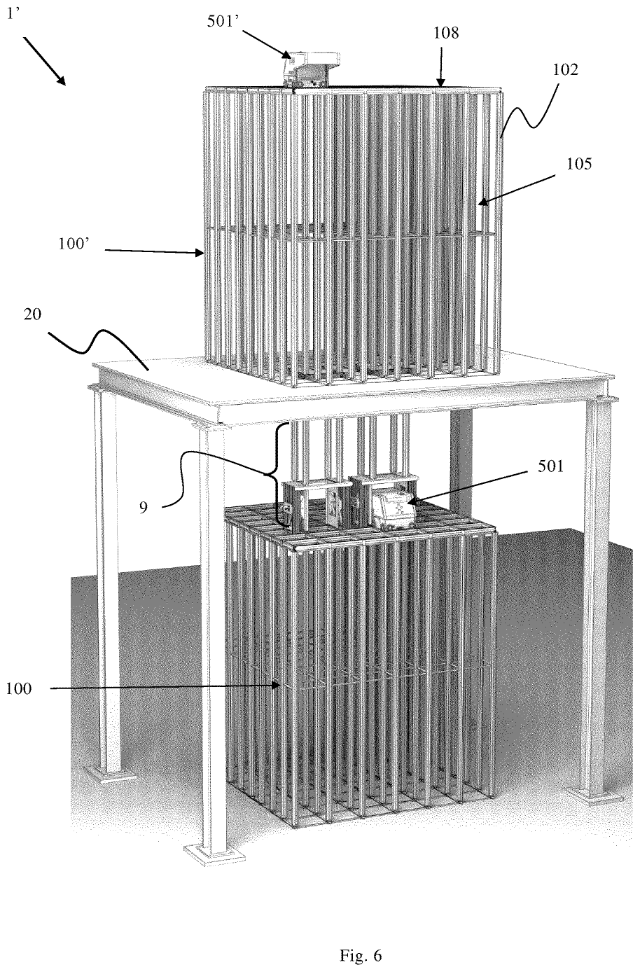

Each of the container handling vehicles 501,501′ features a lifting frame 2 having grippers 3 configured to releasably connect to connector recesses 13 arranged in an upper rim 16 of a storage container 106, see FIGS. 4 and 5. The container handling vehicles 501,501′ are configured to retrieve a storage container 106 via the access opening 112 of a storage column 105.

To allow transfer of storage containers 106 between the first framework structure 100 and the second framework structure 100′, the second framework structure 100′ features a transfer column 8 having an open lower end 19 arranged above an opening 22 in the mezzanine 20. The second container handling vehicle 501′ may use the lifting frame 2 to lower a storage container 106 via the transfer column 8, through the open lower end 19 and the opening 22, towards a buffer column 11 of the first framework structure 100 below.

The vertical movement of the lifting frame 2, and any optional storage container 106 connected thereto, must always be guided to ensure that the lifting frame is lowered correctly into the buffer column 11. Lack of lifting frame 2 guidance may prevent the lifting frame 2 from being lowered into the buffer frame 11 and would cause an unacceptably high occurrence of error. To provide the required guidance of the lifting frame 2, the lower end 19 of the transfer column 8 is connected to the first framework structure by a guiding column 9, such that the lifting frame 2 of the second container handling vehicle 501′ may be lowered from the lower end 19 of the transfer column 8 and into the buffer column 11 of the first framework structure 100 in a reliable manner. The transfer column 8 is functionally similar to a port column 119,120 as shown in FIG. 1, however the lower end 19 is connected to the guiding column 9 instead of a port/workstation.

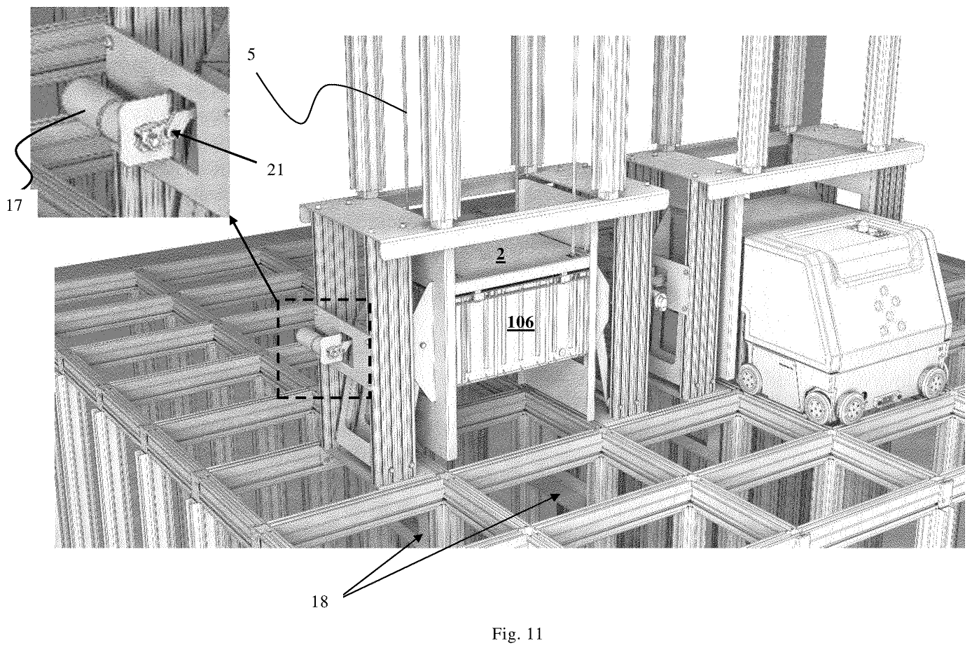

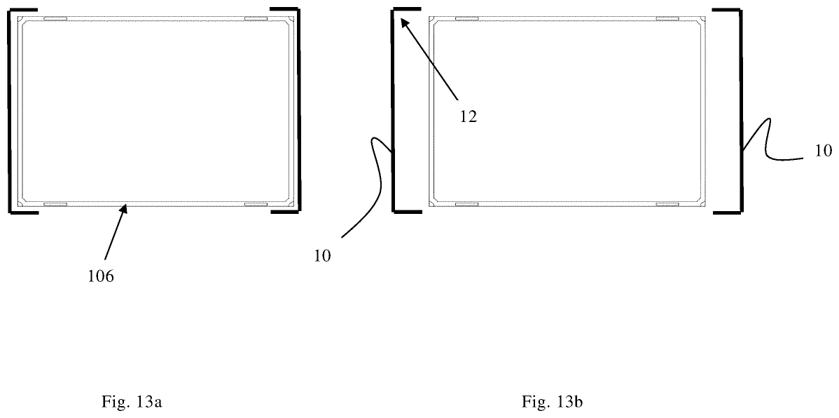

A lower section of the guiding column 9 comprises two vertical guide elements 10. Each guide element 10 has two vertical corner sections 12 configured to accommodate and guide a corresponding corner of the lifting frame 2 of the second container handling vehicle 501′. The guide elements are laterally moveable between a first position and a second position. In the first position, see e.g. the left guiding column in FIG. 11, and FIG. 13a, the guide elements are arranged to guide the vertical movement of a lifting frame 2 being lowered between them. In the second position, see e.g. the right guiding column in FIG. 11, and FIG. 13b, the guide elements 10 are moved relative to the first position, such that a first container handling vehicle 501 may be arranged above the buffer column 11. When the guide elements 10 are in the second position the first container handling vehicle may retrieve a storage container 106 from, or store a storage container in, the buffer column 11.

The lower section of the guiding column 9 comprises a support 25 fixed to the first framework structure 100. The guiding elements 10 are moveably connected to the support 25. An upper section of the guiding column 9 features four vertical profiles 14. An upper end of each of the vertical profiles 14 is connected to the lower end of the transfer column 8, and a lower end of each of the vertical profiles 14 is connected to the support 25. Each of the profiles 14 has vertical corner section configured to accommodate and guide a corresponding corner of the lifting frame 2 of the second container handling vehicle 501′.

The buffer column 11 has a rectangular access opening 113, and each of the corner sections 12 of the guide elements coincides with a respective corner of the access opening 113 when the guide elements 10 are in the first position. The buffer column comprises two stoppers 18 arranged to support a storage container 106 in an upper portion of the buffer column 11, see FIGS. 9 and 11. The stoppers feature a support surface configured to support a bottom of the storage container 106. The support surface is arranged at a distance from an upper end of the buffer column 11. The distance is substantially equal to the height of the storage container 106, such that an upper rim of the storage container 106 is at the level of, or slightly below, an upper level of the rail system 108 of the first framework structure 100. In other embodiments, the stoppers 18 may be arranged at a lower level such that the buffer column 11 may accommodate several storage containers 106 stacked on top of one another.

Each guide element 10 is connected to an actuator assembly comprising a motor 17 and a crank assembly 21. The actuator assembly being configured to move the guide element 10 between the first position and the second position. In the illustrated embodiment, the actuator assembly features a rotary motor 17 and the crank assembly is configured to transform the rotary motion into a linear motion of the guide element 10. In other embodiments, the actuator assembly may feature any suitable mechanical solution suitable for moving the guide elements, such as a linear actuator.

In embodiments where the distance between the first and second framework structure is smaller than in the illustrated storage system, a guiding column may e.g. consist of the illustrated lower section directly connected to the lower end of a transfer column.

The illustrated storage system features two guiding columns 9. The use of multiple guiding columns may provide an even more increased efficiency and flexibility when moving storage containers between the first and second framework structures 100,100′.

The disclosed storage system provides an advantageous method of transporting a storage container 106 between two framework structures 100,100′ of a storage system. The method comprises the steps of:
retrieving a storage container from a storage column 105′ of the second framework structure 100′ by use of the second container handling vehicle 501′;
having the guide elements 10 arranged in the first position; and
lowering the storage container through the transfer column 8 and the guiding column 9 and into the buffer column 11;
moving the guide elements to the second position; and
retrieving the storage container from the buffer column by use of the first container handling vehicle 501′.

Also described herein are the following numbered clauses:
Clause 1. A storage system (1) for storage containers, the storage system comprising a first framework structure (100), upon which a first container handling vehicle (501) is arranged to operate, and a second framework structure (100′) upon which a second container handling vehicle (501′) is arranged to operate;
   the first framework structure is arranged below the second framework structure, and each of the first and the second framework structures defines a plurality of storage columns (105,105′) in which storage containers (106) are arranged one on top of another in vertical stacks;
   each of the first container handling vehicle (501) and the second container handling vehicle (501′) comprises a vehicle body (6) and a vertically moveable lifting frame (2) for lifting a storage container (106) from the storage columns (105,105′);
   the second framework structure (100′) comprises a transfer column (8) through which the second container handling vehicle may transfer a storage container, the transfer column features an open lower end (19);
   the lower end of the transfer column is connected to the first framework structure by a guiding column (9) such that the lifting frame (2) of the second container handling vehicle may be guided by the guiding column as it is lowered from the lower end of the transfer column to a buffer column (11) of the first framework structure (100);
   at least a lower section of the guiding column comprises vertically extending guide elements (10), the guide elements being moveable between a first position and a second position,
   in the first position the guide elements are arranged to guide the vertical movement of a lifting frame (2) being lowered between them, and
   in the second position the guide elements (10) are moved relative to the first position such that the first container handling vehicle (501) may move into a location on the first framework above the buffer column unobstructed by the guide elements.
Clause 2. A storage system according to claim 1, wherein the guide elements (10) are moved away from one another when moving from the first position to the second position such that the first container handling vehicle (501) may move in between them.
Clause 3. A storage system according to claim 1 or 2, wherein the guide elements are laterally moveable between the first position and the second position.
Clause 4. A storage system according to any of the preceding claims, wherein the guide elements are closer to a centreline of the guiding column (9) when the guide elements are in the first position than when the guide elements are in the second position.
Clause 5. A storage system according to any of the preceding claims, wherein the lower section of the guiding column (9) comprises two guide elements (10), each guide element featuring two vertical corner sections (12), each of the corner sections configured to accommodate and guide a corresponding corner of the lifting frame (2) of the second container handling vehicle (501′).
Clause 6. A storage system according to claim 5, wherein the buffer column (11) has a rectangular access opening (113), and each of the corner sections coincide with a respective corner of the access opening (113) when the guide elements are in the first position.
Clause 7. A storage system according to any of the preceding claims, wherein the guide elements are connected to at least one actuator assembly (17,21), the actuator assembly being configured to move the guide elements (10) between the first position and the second position.
Clause 8. A storage system according to any of the preceding claims, wherein the guide elements are taller than the first container handling vehicle (501).
Clause 9. A storage system according to any of the preceding claims, wherein centrelines of the transfer column (8), the guiding column (9) and the buffer column (11) are colinear.
Clause 10. A storage system according to any of the preceding claims, wherein each of the first framework structure and the second framework structure comprises a rail system (108) upon which the first container handling vehicle and the second container handling vehicle, respectively, may move in two perpendicular directions above the storage columns.
Clause 11. A storage system according to any of the preceding claims, wherein the lower section of the guiding column comprises a support (25) fixed to the first framework structure (100), and the guiding elements are moveably connected to the support.
Clause 12. A storage system according to claim 11, wherein an upper section of the guiding column comprises four vertical profiles (26), each profile comprising a vertical corner section (27) configured to accommodate and guide a corresponding corner of the lifting frame (2) of the second container handling vehicle (501′).
Clause 13. A storage system according to claim 12, wherein an upper end of each of the vertical profiles (26) are connected to the lower end of the transfer column (8) and a lower end of each of the vertical profiles are connected to the support (25).
Clause 14. A storage system according to any of the preceding claims, wherein the buffer column comprises at least one stopper (18) arranged to support a storage container (106) in an upper portion of the buffer column (11).
Clause 15. A storage system according to any of the preceding claims, wherein the lifting frame (2) is configured to releasably connect to an upper portion of a storage container.
Clause 16. A method of transferring a storage container in a storage system according to any of claims 1-11, the method comprising the steps of:
retrieving a storage container from a storage column (105′) of the second framework structure (100′) by use of the second container handling vehicle (501′);
having the guide elements (10) arranged in the first position; and
lowering the storage container through the transfer column (8) and the guiding column (9) and into the buffer column (11);
moving the guide elements to the second position; and
retrieving the storage container from the buffer column by use of the first container handling vehicle (501′).

### LIST OF REFERENCE NUMBERS

1 Prior art automated storage and retrieval system
2 Lifting frame, first type of lifting frame
3 Container connector, grippers
4 Guiding pin
5 Lifting bands
6 Vehicle body
7 Guiding pin recess
8 Transfer column
9 Guiding column
10 Guide element
11 Buffer column
12 Vertical corner section
13 Connector recess
14 Sidewall of storage container
15 Lower bottom surface of lifting frame
16 Upper rim of storage container
17 Rotary motor or actuator
18 Stopper
19 Lower open end
20 Mezzanine
21 Crank assembly
22 Opening in mezzanine
23 First set of wheels, first direction (X)
24 Second set of wheels, second direction (Y)
25 Support
26 Vertical profile, upper section of guiding column
27 Vertical corner section
100,100′ First framework structure, second framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening, storage column
113 Access opening, buffer column
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
Y Second direction
Z Third direction

1-17. (canceled)

18. A storage system for storage containers, the storage system comprising:
a first framework structure, for operation of a container handling vehicle, comprising a vehicle body and a vertically moveable lifting frame for lifting a storage container from the storage columns, thereon;
a second framework structure for operation of a container handling vehicle, comprising a vehicle body and a vertically moveable lifting frame for lifting a storage container from the storage columns thereon;
the first framework structure being arranged below the second framework structure, and each of the first and the second framework structures defining a plurality of storage columns for storage containers arranged one on top of another in vertical stacks;
the second framework structure comprising a transfer column for transferring of a storage container therethrough by a container handling vehicle, the transfer column featuring an open lower end;
the lower end of the transfer column being connected to the first framework structure by a guiding column for guiding the lifting frame of a container handling vehicle from the lower end of the transfer column to a buffer column of the first framework structure; in which at least a lower section of the guiding column comprises vertically extending guide elements, the guide elements being moveable between a first position and a second position;
wherein in the first position the guide elements are arranged to guide the vertical movement of a lifting frame being lowered between them; and
wherein in the second position the guide elements are moved relative to the first position such that a container handling vehicle may move into a location on the first framework above the buffer column unobstructed by the guide elements.

19. The storage system according to claim 18, the storage system further comprising a first container handling vehicle arranged to operate on the first framework structure, and a second container handling vehicle arranged to operate on the second framework structure;
each of the first container handling vehicle and the second container handling vehicle comprising a vehicle body and a vertically moveable lifting frame for lifting a storage container from the storage columns;
the second container handling vehicle being arranged to transfer a storage container through the transfer column;
the guiding column being arranged to guide the lifting frame of the second container handling vehicle as it is lowered from the lower end of the transfer column to the buffer column of the first framework structure; and
the first container handling vehicle being arranged to move into a location on the first framework above the buffer column unobstructed by the guide elements when in the second position.

20. The storage system according to claim 18, wherein the guide elements are moved away from one another when moving from the first position to the second position such that a container handling vehicle may move in between them.

21. The storage system according to claim 18, wherein the guide elements are laterally moveable between the first position and the second position.

22. The storage system according to claim 18, wherein the guide elements are closer to a centreline of the guiding column when the guide elements are in the first position than when the guide elements are in the second position.

23. The storage system according to claim 18, wherein the lower section of the guiding column comprises two guide elements, each guide element featuring two vertical corner sections, each of the corner sections configured to accommodate and guide a corresponding corner of a lifting frame of a container handling vehicle.

24. The storage system according to claim 23, wherein the buffer column has a rectangular access opening, and each of the corner sections coincide with a respective corner of the access opening when the guide elements are in the first position.

25. The storage system according to claim 18, wherein the guide elements are connected to at least one actuator assembly, the actuator assembly being configured to move the guide elements between the first position and the second position.

26. The storage system according to claim 19, wherein the guide elements are taller than the first container handling vehicle.

27. The storage system according to claim 18, wherein centrelines of the transfer column, the guiding column and the buffer column are colinear.

28. The storage system according to claim 18, wherein each of the first framework structure and the second framework structure comprises a rail system arranged for movement of a container handling vehicle in two perpendicular directions above the storage columns.

29. The storage system according to claim 18, wherein the lower section of the guiding column comprises a support fixed to the first framework structure, and the guiding elements are moveably connected to the support.

30. The storage system according to claim 29, wherein an upper section of the guiding column comprises four vertical profiles, each profile comprising a vertical corner section configured to accommodate and guide a corresponding corner of a lifting frame of a container handling vehicle.

31. The storage system according to claim 30, wherein an upper end of each of the vertical profiles being connected to the lower end of the transfer column and a lower end of each of the vertical profiles being connected to the support.

32. The storage system according to claim 18, wherein the buffer column comprises at least one stopper arranged to support a storage container in an upper portion of the buffer column.

33. The storage system according to claim 18, wherein the lifting frame is configured to releasably connect to an upper portion of a storage container.

34. A method of transferring a storage container in a storage system according to claim 19, the method comprising the steps of:
retrieving a storage container from a storage column of the second framework structure by use of the second container handling vehicle;
having the guide elements arranged in the first position; and
lowering the storage container through the transfer column and the guiding column and into the buffer column;
moving the guide elements to the second position; and
retrieving the storage container from the buffer column by use of the first container handling vehicle.
